(19) United States
(12) Patent Application Publication
(10) Pub. No.: US 2010/0046448 A1
(43) Pub. Date: Feb. 25, 2010

(54) Single Bit Segmentation Indicator

(75) Inventors: Janne Peisa, Espoo (FI); Mats Sagfors, Kyrkslatt (FI); Johan Torsner, Masaby (FI); Stefan Wager, Espoo (FI); Anna Larmo, Espoo (FI)

Correspondence Address: COATS & BENNETT, PLLC, 1400 Crescent Green, Suite 300, Cary, NC, 27518, US

(73) Assignee: TELEFONAK TIEBOLAGET LM ERICSSON (, STOCKHOLM (SE)

(21) Appl. No.: 12/519,320

(22) PCT Filed: Dec. 10, 2007
(86) PCT No.: PCT/SE07/50968

§ 371 Date: Jun. 15, 2009

(30) Foreign Application Priority Data
Dec. 15, 2006 (SE) 0602745-2

(51) Int. Cl. H04W 72/00

(52) U.S. Cl. 370/329

(57) ABSTRACT

Data units according to the first transmission format are divided into data units according to the second transmission format. A single-bit segmentation indicator inserted into the header of a data unit according to the second transmission format indicates whether the data unit according to the first transmission format ends in a data unit according to the second transmission format.

### TECHNICAL FIELD

The present invention relates generally to radio link control for high speed packet data services in wireless networks and, more particularly, to segmentation and reassembly of IP packets into RLC protocol data units.

### BACKGROUND

Radio link control (RLC) is a protocol used in mobile communication networks to reduce the error rate over wireless channels. Through the use of forward error correction and retransmission protocols, the physical layer can typically deliver packets with an error rate on the order of 1%. The transport control protocol (TCP) used in most IP networks, however, requires an error rate in the order of 0.0% for reliable communications. The radio link control (RLC) protocol bridges the gap between the error performance of the physical layer and the requirements for reliable communication over TCP networks.

The RLC protocol is responsible for the error free, in-sequence delivery of IP packets over the wireless communication channel. RLC divides IP packets, also called RLC service data units (SDUs), into smaller units called RLC protocol data units (PDUs) for transmission over the wireless communication channel. A retransmission protocol is used to ensure delivery of each RLC PDU. If an RLC PDU is missed at the receiver, the receiver can request retransmission of the missing RLC PDU. The RLC SDU is reassembled from the received RLC PDUs at the receiver.

Because IP packets can be large, RLC provides a mechanism for segmentation and concatenation of IP packets. Segmentation allows IP packets to be divided into multiple RLC PDUs for transmission. Concatenation enables parts of multiple IP packets to be included in a single RLC PDU. The header of the RLC PDU conventionally includes a length indicator (LI) to indicate the length of each IP packet to enable reassembly of the IP packets at the receiver.

For Release 7 of the Wideband Code Division Multiple Access (WCDMA) standard as standardized by the 3^{rd} Generation Partnership project (3GPP), it has been proposed to eliminate the concatenation functionality and replace the length indicator in the RLC header with a segmentation indicator. It has been proposed that a 2-bit segmentation indicator could be used to indicate one of four different segmentation possibilities:
one RLC SDU fits exactly into one RLC PDU;
an RLC SDU starts in an RLC PDU and continues to the next RLC PDU;
a segment of an RLC SDU fills the RLC PDU; and
an RLC SDU ends in the RLC PDU.

### SUMMARY

The proposal described above requires a new acknowledged mode format for the RLC PDU. It is thus an object of the present invention to have a segmentation indicator that enables reuse of existing acknowledge mode formats for RLC PDUs.

The present invention provides a method for segmenting data units according to a first transmission format into data units according to a second transmission format. Data units according to the first transmission format are divided into two or more segments and a header is added to each segment to create data units according to the second transmission format. A single-bit segmentation indicator inserted into the header of the data unit according to the second transmission format indicates whether the data unit according to the first transmission format ends in a data unit according to the second transmission format.

The present invention also relates to a transmitter unit including an RLC processor configured to perform the method according to the present invention.

In one exemplary embodiment, the data units according to the first transmission format comprise RLC SDUs and the data units according to a second transmission format comprise RLC PDUs. Assuming that concatenation is not used, the single bit segmentation indicator, in combination with sequence numbering of RLC PDUs, is sufficient to perform the segmentation and reassembly functions of the RLC protocol. The receiver may determine the start of the RLC SDU from the sequence number of the RLC PDU terminating the last RLC SDU. Based on this information, the receiver may determine the sequence numbers of all RCL PDUs corresponding to a single RLC SDU.

The present invention allows the advantage that one bit in the segmentation indication field of the Flexible RLC PDU format can be saved and, in case a new FMD format is specified, that a spare bit is provided which can be used for future extensions or added functionality.

### BRIEF DESCRIPTION OF THE DRAWINGS

Exemplary embodiments of the invention will now be described in more detail with reference to the accompanying schematic drawings.

FIG. 1 illustrates an exemplary communication network.

FIG. 2 illustrates segmentation of RLC SDUs into RLC PDUs.

FIG. 3 illustrates an exemplary RLC PDU format.

FIG. 4 illustrates an exemplary method for segmenting RLC SDUs into RLC PDUs.

FIG. 5 illustrates an exemplary method for reassembling RLC SDUs from RLC PDUs

### DETAILED DESCRIPTION

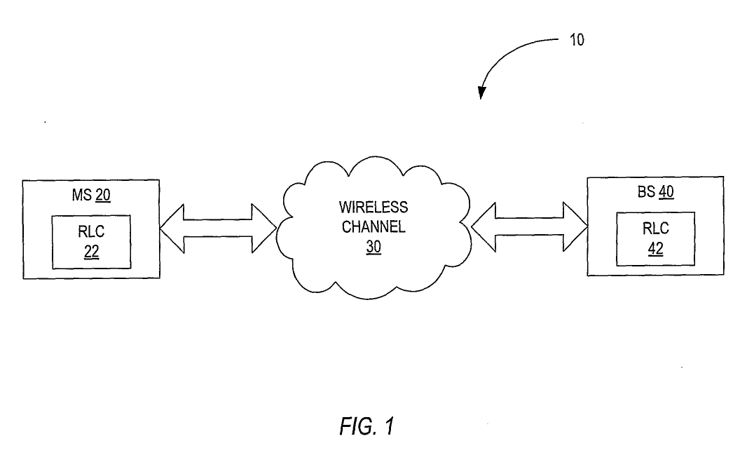

Referring now to the drawings, FIG. 1 illustrates a communications network 10 wherein mobile stations 20 communicate over a communication channel 30 with a base station 40. Base station 40 is part of an access network (AN) that provides connection to an IP network, such as the Internet. The mobile station 20 may transmit packet data to, and receive packet data from, the base station 40 over the wireless communication channel 30. Although the following discussion assumes that base station 40 and mobile station 20 operate according to the Wideband Code Division Multiple Access (WCDMA) standard by the 3^{rd} Generation Partnership Project (3GPP) the principles described herein may be applied to other standards and access technologies.

In WCDMA networks, hybrid ARQ is employed at the physical layer to provide an error rate of approximately 1%. The transport control protocol (TCP), however, requires an error rate in the order of 0.01% for reliable communications. The radio link control (RLC) protocol bridges the gap between the error performance of the physical layer and the requirements for reliable communication over TCP networks. The RLC functionality is implemented by an RLC processor 22 in the mobile station 20, and by an RLC processor 42 in the base station 40.

In WCDMA, the RLC processor 22, 42 at the transmitting station (e.g. mobile station 20 for uplink transmissions and base station 40 for downlink transmissions) receives compressed IP packets from the packet data convergence protocol (PDCP) layer. The IP packets are also known as RLC service data units (SDUs). RLC divides the SDUs into segments, and adds a header to each segment to create RLC protocol data units (PDUs). The PDUs are then transmitted over the wireless communication channel 30 to the receiver. On the uplink, the PDUs are transmitted by a transmitter at the mobile station 20 to a receiver at the base station 40. On the downlink, the PDUs are transmitted by a transmitter at the base station 40 to a receiver at the mobile station 20. When a missing PDU is detected by the RLC processor 22, 42 at the receiver, it sends a negative acknowledgement (NACK) to request retransmission of the missing PDU. When the PDUs corresponding to a single SDU are received, the SDU is reassembled and passed to upper layer protocols.

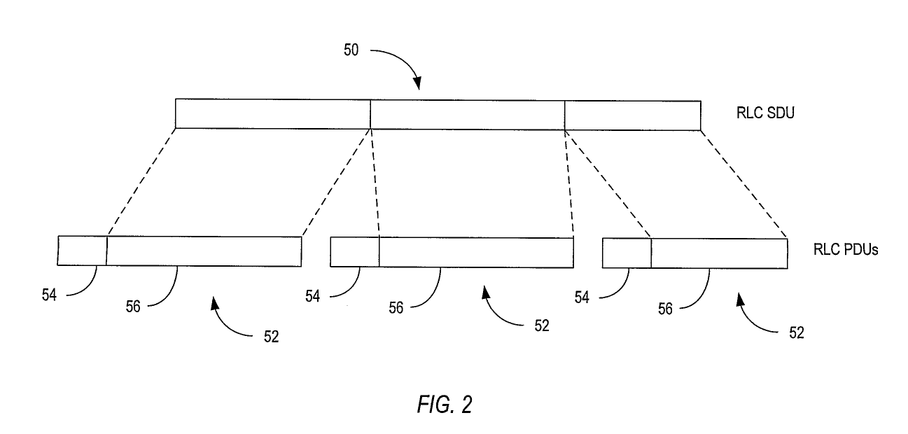

FIG. 2 illustrates the segmentation of RLC SDUs into RLC PDUs. In the example shown in FIG. 2, an SDU 50 is divided into three segments to form three PDUs 52. The number of segments may vary depending on the relative sizes of SDU 50 and PDU 52. Each PDU 52 includes a header 54 and payload 56 that contains one segment of the SDU 50. The size of a PDU 52 may be flexible and the operator may set a predetermined maximum size for a PDU 52. During the segmentation process, RLC processor 22, 42 divides the SDU 50 into segments based on the maximum size criterion. The size of the final SDU 50 is allowed to vary so that padding or concatenation is not required to fill the final PDU 52.

To reassemble SDUs 50 from PDUs 52, the RLC processor 22, 42 at the receiver needs to identify the PDUs 52 corresponding to a single SDU 50. Assuming that concatenation is not used, the segmentation indicator in the header 54 of a PDU 52 may be used to demarcate the end of an SDU 50. According to one embodiment, the segmentation indicator comprises a single bit that is set to a first value if the SDU 50 continues into the next PDU 52, and is set to a second value if the SDU 50 terminates in the PDU 52. For example, the segmentation indicator may be set to a value of “0” to indicate that the SDU 50 continues into the next PDU 52, and to a value of “1” to indicate that the SDU 50 ends in the current PDU 52. Based on the segmentation indicator and the sequence numbers of the PDUs 52, the RLC processor 22, 42 may determine which PDUs 52 correspond to an SDU 50. In an alternate embodiment, the segmentation indicator may be used to demarcate the beginning of an SDU 50, but otherwise operates in the same manner.

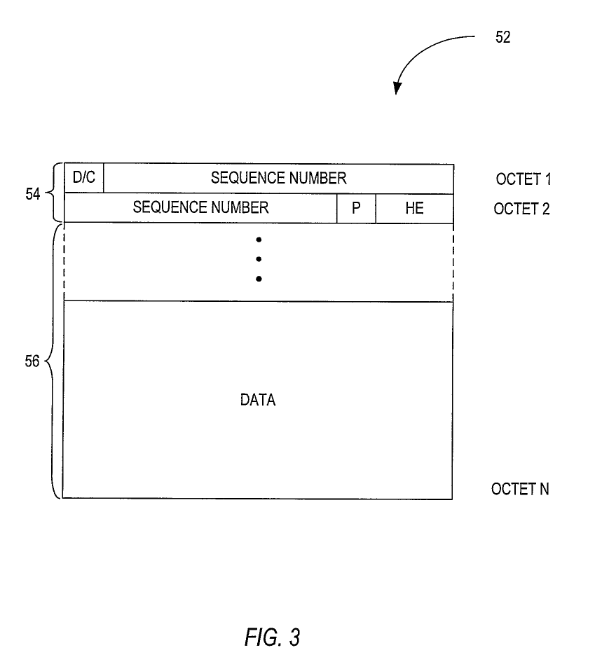

FIG. 3 illustrates an exemplary PDU format according to one embodiment. The header 54 includes data/control (D/C) field, a sequence number field, a polling bit (P) field, and a header extension (HE) field. The D/C filed indicates the type (e.g., data or control) of the PDU 52. The sequence number field spans the first and second octets of the PDU 52 and contains the sequence number of the PDU 52. The P field is used to request a status report. The HE field is a two-bit field including the segmentation indicator and a spare bit. The segmentation indicator is used to indicate whether the PDU 52 contains the last segment of an SDU 50. The spare bit may be used for purposes other than segmentation. According to alternative embodiments other PDU formats may be used as well. Some PDU formats may have a separate segmentation indicator (SI) field with a single bit used as the segmentation indicator.

Table 1 below illustrates one method of implementing the segmentation indicator using the PDU format shown in FIG. 3.

TABLE 1
Segmentation Indicator (First Embodiment)

| Value | Description |
|---|---|
| x0 | The RLC SDU in this RLC PDU continues |
| | into the next PLC PDU. |
| x1 | The RLC SDU ends in this RLC PDU. |

As shown in Table 1, the least significant bit is set to “0” to indicate that the SDU 50 continues into the next PDU 52, and is set to “1” to indicate that the SDU 50 ends in the current PDU 52. In this embodiment, the most significant bit, represented by an “x”, is a spare bit. The spare bit may be used, for example, to indicate whether the PDU 52 is transmitted for the first time. For example, the spare bit may be set to a value of “0” to indicate that the PDU 52 is transmitted for the first time, and to a value of “1” to indicate that the PDU 52 is a retransmission of a previously-transmitted PDU 52. Indicating whether the PDU 52 is retransmitted enables prioritization of retransmitted PDUs 52 at the base station 40, which is beneficial for performance.

Table 2 illustrates an alternative implementation of the segmentation indicator.

TABLE 2
Segmentation Indicator (Second Embodiment)

| Value | Description |
|---|---|
| 0x | The RLC SDU in this RLC PDU continues |
| | into the next PLC PDU. |
| 1x | The RLC SDU ends in this RLC PDU. |

As shown by Table 2, the most significant bit functions as the segmentation indicator, while the least significant bit functions as the spare bit. The segmentation indicator is set to a value of “0” or “1,” depending on whether the SDU 50 ends in the current PDU 52. The spare bit may be used to indicate whether the PDU 52 is transmitted for the first time or is a retransmission of a previously-transmitted PDU 52.

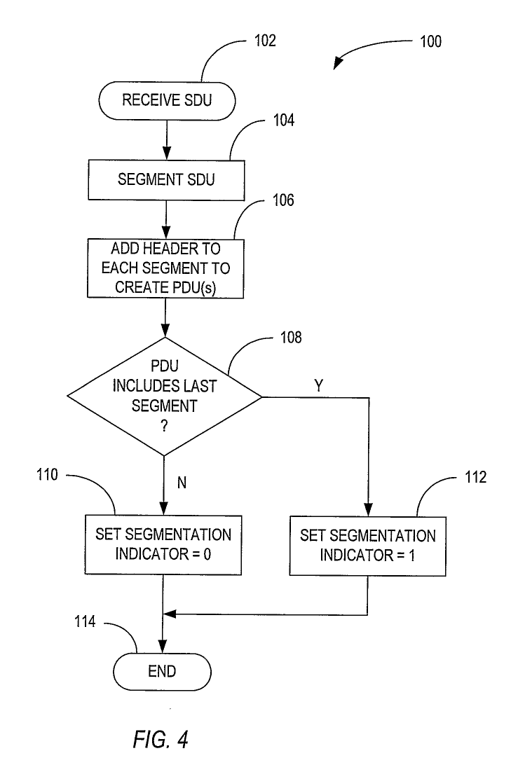

FIG. 4 illustrates an exemplary procedure 100 implemented by an RLC processor 22, 42 at a transmitter for segmenting SDUs 50 into PDUs 52. The transmitter may be located in either the mobile station 20 for uplink communications, or the base station 40 for downlink communications. Procedure 100 begins when the RLC processor 22, 42 receives an SDU 50 from a higher layer protocol (block 102). The RLC processor 22, 42 segments the SDU 50 (block 104) and adds a header to each segment to create one or more PDUs 52 (block 106). For each PDU 52 created, the RLC processor 22, 42 determines whether the SDU 50 ends in the PDU 52 (block 108). If not, the RLC processor 22, 42 sets the segmentation indicator of the PDU 52 equal to 0 (block 110). If the SDU 50 ends in the PDU 52, the RLC processor 22, 42 sets the segmentation indicator of the PDU 52 equal to 1 (block 112). This procedure 100 is repeated for each PDU 52 and ends when the last PDU 52 is processed (block 114).

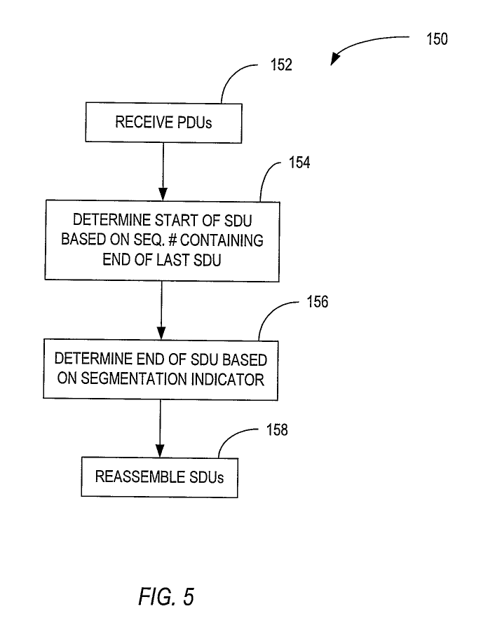

FIG. 5 illustrates an exemplary procedure 150 implemented by the RLC processor 22, 42 at a receiver for reassembling SDUs 50 from received PDUs 52. The receiver may be located in either the mobile station 20 for downlink communications, or the base station 40 for uplink communications. The RLC processor 22, 42 receives PDUs 52 comprising one or more SDUs 50 (block 152). For each SDU 50, the start of the SDU 50 is determined based on the sequence number of the PDU 52 containing the end of the last SDU 50 (block 154). For example, if the last SDU 50 ends in the PDU 52 with sequence number n, the start of the next SDU 50 will begin with the PDU 52 containing the sequence number n+1. The RLC processor 22, 42 determines the end of each SDU 50 based on the segmentation indicator in the header of the PDU 52 (block 156). Because the RLC processor 22, 42 knows the sequence numbers of the PDUs 52 where the SDU 50 begins and ends, it may then identify all of the PDUs 52 belonging to the same SDU 50 and reassemble the SDU 50 (block 158).

The present invention may, of course, be carried out in other ways than those specifically set forth herein without departing from essential characteristics of the invention. The present embodiments are to be considered in all respects as illustrative and not restrictive, and all changes coming within the meaning and equivalency range of the appended claims are intended to be embraced therein.

1-12. (canceled)

13. A method of segmenting Radio Link Control (RLC) Service Data Units (SDUs) into RLC Protocol Data Units (PDUs) for transmission in an acknowledged mode, the method comprising:
inserting an indicator field in a header of an RLC PDU; and
setting a predetermined indicator bit of the indicator field to a pre-determined value if an RLC SDU ends in the RLC PDU.

14. The method of claim 13 wherein the indicator field comprises a single-bit field.

15. The method of claim 13 wherein the indicator field comprises a two-bit field including the indicator bit and a spare bit.

16. The method of claim 15 wherein the spare bit is used for a purpose other than indicating a segmentation of data units according to a first transmission format.

17. The method of claim 16 wherein the spare bit is used to indicate whether the data unit, according to the second transmission format, is a retransmission of a previously transmitted data unit.

18. A transmitter in a mobile communication system comprising:
a Radio Link Control (RLC) processor configured to segment RLC Service Data Units (SDUs) into RLC Protocol Data Units (PDUs) to be transmitted in an acknowledged mode; and
the RLC processor being configured to:
insert an indicator field in a header of an RLC PDU; and
set a predetermined indicator bit of the indicator field to a pre-determined value if an RLC SDU ends in the RLC PDU.

19. The transmitter of claim 18 wherein the indicator field comprises a single-bit field.

20. The transmitter of claim 18 wherein the indicator field comprises a two-bit field including the indicator bit and a spare bit.

21. The transmitter of claim 20 wherein the RLC processor is further configured to use the spare bit for a purpose other than indicating a segmentation of data units according to the first transmission format.

22. The transmitter of claim 21 wherein the RLC processor is further configured to use the spare bit to indicate whether the data unit, according to the second transmission format, is a retransmission of a previously transmitted data unit.
